(19) United States
(12) Patent Application Publication
(10) Pub. No.: US 2004/0148428 A1
(43) Pub. Date: Jul. 29, 2004

(54) Methods and apparatus for supporting an internet protocol (IP) version independent mobility management system

(76) Inventor: George Tsirtsis, London (GB)

Correspondence Address: STRAUB & POKOTYLO, 620 TINTON AVENUE, BLDG. B, 2ND FLOOR, TINTON FALLS, NJ, 07724, US

(21) Appl. No.: 10/373,457

(22) Filed: Feb. 25, 2003

Related U.S. Application Data
(60) Provisional application No. 60/443,236, filed on Jan. 28, 2003.

(51) Int. Cl. G06F 15/16; G06F 15/173

(52) U.S. Cl. 709/238; 709/236

(57) ABSTRACT

Methods and apparatus for supporting network layer protocol version independent mobility management are described. In accordance with the present invention, the signaling method used to set-up the redirection (encapsulation or tunnel) is separated from the type of redirection being set-up. Through the use of a Protocol Independent Mobility Management Protocol and/or modules for implementing one or more aspects of the Protocol of the present Invention, Mobile IPv4 and IPv6 may run on top of any version of the network layer and can set-up tunnels of any network layer version over any other network layer version. Various features of the invention are used to establish tunnels which are capable of being used to commutate IPv4 and/or IPv6 packets. Other features are directed to storing and using state information which allows IPv4 and/or IPv6 packets to be sent through a tunnel established using IPv4 or IPv6 type signaling.

### RELATED APPLICATIONS

The present application claims the benefit of the filing date of U.S. Provisional Patent Application S. No. 60/443,236, filed Jan. 28, 2003, which has the same title as the present application and which is hereby expressly incorporated by reference.

### FIELD OF THE INVENTION

The present invention is directed to mobility management in a communications system and, more particularly, to methods and apparatus for network layer protocol version independent mobility management.

### BACKGROUND

Internet Protocol (IP) technology is designed to enable packet-switched interconnection of a heterogeneous set of computers and communication networks. A potentially diverse set of network and link layer technologies are interconnected through nodes, e.g., gateways (or routers), that provide a packet forwarding service. Information is transferred between end nodes (or hosts) as blocks of data called datagrams, where source and destination hosts are identified by fixed length addresses. Routing in IP internetworks is connectionless in nature, in that datagrams are forwarded between routers on a hop-by-hop basis using the destination address in the datagram. The most widely used version of the Internet Protocol is its version 4, also known as IPv4. Due to a number of reasons a new version of the protocol was also created known as IPv6. It is expected that networks currently using IPv4 will eventually support IPv6 while it is likely that there will be an extended period of co-existence of both versions of the Internet Protocol.

Mobile IPv4 (Ref: IETF RFC 2002) enables an IPv4 host, also called a “mobile node” in the context of Mobile IPv4, to dynamically change its point of attachment to the network, yet remain contactable via a previously given “home address”. To achieve this a temporary local address or “care of address” is associated with the mobile node when it visits a foreign network corresponding to a visited domain. In some cases the care of address is that of a “foreign agent” that assists in this process, while in other cases the care of address may be directly assigned to the mobile node. The care of address is registered back on the home network in a node referred to as the “home agent”. The home agent intercepts packets destined to the home address of the mobile node and redirects the packets, by means of encapsulation and tunneling, towards the care of address associated with mobile node in the visited network. Upon delivery to the care of address, the encapsulation is removed and the original packet destined to the home address is delivered to the mobile node.

Mobile IPv6 enables an IPv6 host, also called a “mobile node” in the context of Mobile IPv6, to dynamically change its point of attachment to the network, yet remain contactable via a previously given “home address”. The mechanisms used are similar but not identical to the mechanisms described above in relation to Mobile IPv4.

Since Mobile IPv4 and Mobile IPv6 are not identical, it is important that a mobile node support both IPv4 and IPv6, including Mobile IPv4 and Mobile IPv6 signaling, so that it can maintain connectivity with both IP versions. Currently, Mobile IPv4 only works if IPv4 is supported between the mobile node and its home agent. Similarly, at the present time, Mobile IPv6 only works if IPv6 is supported between the mobile node and its home agent. In the case of end nodes that support IPv4 and IPv6 this normally requires that an Access Node used to couple the end node to the network establish both a Mobile IPv4 and a Mobile IPv6 tunnel between the Access Node and the mobile node's home agent. In order to increase system flexibility it would be beneficial if Mobile IPv4 and Mobile IPv6 signaling between a home agent node and a foreign agent node could be supported without having to establish separate Mobile IPv4 and Mobile IPv6 tunnels between a mobile node's home agent and foreign agent.

### BRIEF DESCRIPTION OF THE FIGURES

FIG. 1 illustrates an exemplary system based on Mobile IP which implements the present invention.

FIG. 2 illustrates an exemplary end node, e.g., mobile node, which can be used in the exemplary system of FIG. 1.

FIG. 3 illustrates an exemplary access node which can be used in the exemplary system of FIG. 1 to operate as a Foreign Agent.

FIG. 4 illustrates an exemplary Home agent node which can be used in the exemplary system of FIG. 1.

FIG. 5 illustrates the communication of IPv4 and IPv6 signals over an IPv4 tunnel established in accordance with the present invention.

FIG. 6 illustrates the communication of IPv4 and IPv6 signals over an IPv6 tunnel established in accordance with the present invention.

### SUMMARY OF THE INVENTION

The present invention is directed to methods and apparatus for network layer protocol version independent mobility management.

In accordance with the present invention, the signaling method used to set-up the redirection (encapsulation or tunnel) is separated from the type of redirection being set-up. Through the use of a Protocol Independent Mobility Management Protocol and/or modules for implementing one or more aspects of the Protocol of the present Invention, Mobile IPv4 and IPv6 may run on top of any version of the network layer and can set-up tunnels of any network layer version over any other network layer version. Various features of the invention are directed to establishing tunnels which are capable of being used to commutate IPv4 and/or IPv6 packets. In accordance with one feature of the invention, messages used to establish a tunnel, e.g., between a home agent and either a foreign agent or end node such as a mobile node, include first and second mobile IP home addresses, where the formats of the two home addresses are different. In some embodiments, one of the two home addresses is in a 32 bit format in accordance with IPv4 while the second address is a 128 bit address in the format of an IPv6 address.

In cases where IPv6 signaling is used, as extended in accordance with the invention, to establish a tunnel, the two home address included in a message used to establish a tunnel may have the same total number of bits, i.e., 128 bits, but with one of the two address being in a format which includes multiple padding bits, e.g., 94 padding bits used to pad a 32 bit home address to fit in a 128 bit address space provided in IPv6.

Other features are directed to storing and using state information which allows IPv4 and/or IPv6 packets to be sent through a tunnel established using IPv4 or IPv6 type signaling. In accordance with these features of the present invention, multiple addresses, at least two of which have different formats, e.g., numbers of bits, are associated in state information used by a home agent with a common destination address, e.g., a care-of-address or mobile node address. In the case where the different addresses correspond to different versions of IP, this results, in accordance with the present invention, in IP packets corresponding to different versions of IP being transmitted by the home agent through a single tunnel through the use of, e.g., encapsulation.

Though the use of the tunnel establishment and communication techniques of the present invention, IPv4 and/or IPv6 packets can be communicated through a tunnel established using either IPv4 or IPv6 type signals in accordance with the present invention.

Numerous additional features, embodiments and benefits of the present invention will be apparent in view of the detailed description which follows.

### DETAILED DESCRIPTION

The present invention is directed to methods and apparatus for supporting network layer protocol version independent mobility management. In accordance with the present invention, the signaling method used to set-up the redirection (encapsulation or tunnel) is separated from the type of redirection being set-up. Through the use of a Protocol Independent Mobility Management Protocol and/or modules for implementing one or more aspects of the Protocol of the present Invention, Mobile IPv4 and IPv6 may run on top of any version of the network layer and can set-up tunnels of any network layer version over any other network layer version.

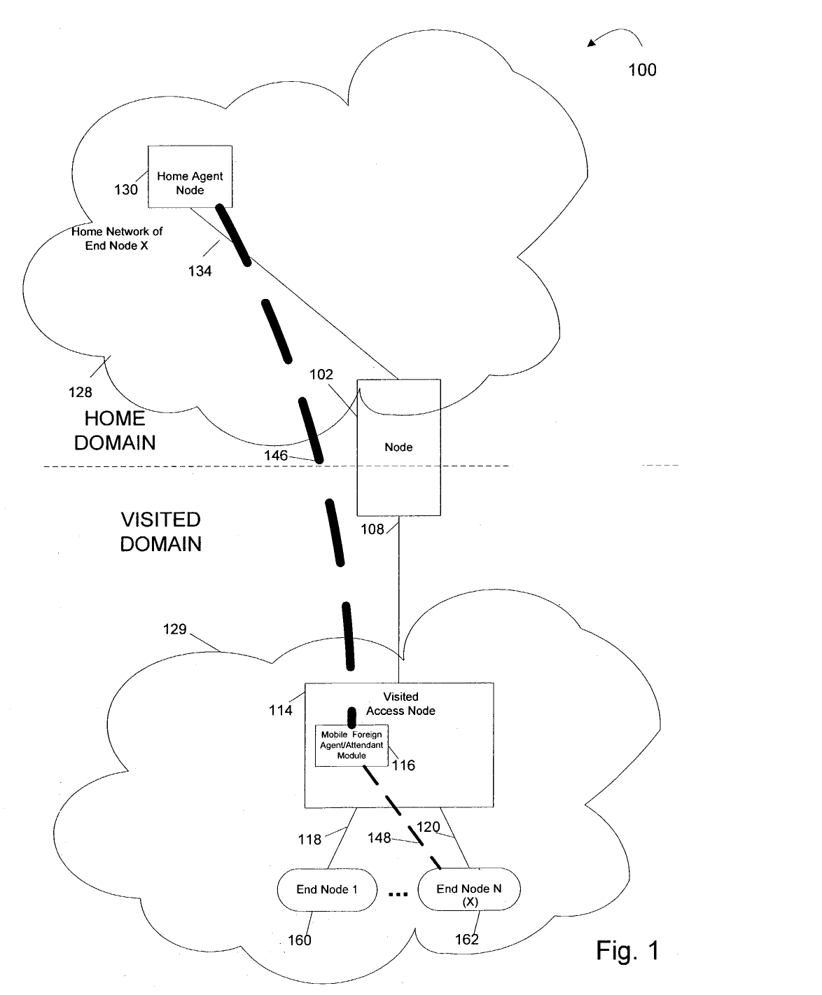

FIG. 1 illustrates an exemplary system 100 based on Mobile IP which implements the present invention. The depicted system 100 comprises a first network 128 coupled to a second network 129 by an intermediate network node 102. The first network 128 is used as a home domain for purposes of explaining the invention while network 129 corresponds to a visited domain. Network 129 comprises access node 114 which provides connectivity to a plurality of N end nodes (160, 162) via corresponding access links (118, 120). Network 128 comprises home agent node 130 which provides mobility management to end nodes registered with it e.g.: end node X 162 in FIG. 1. Interconnectivity between the nodes 114, 130 is provided through network links 108, 134 and intermediate network node 102.

In the depicted system 100, end node X 162 uses Mobile IP to maintain reachability, while its present point of attachment to the network is through visited access node 114. End node X 162 has registered the address associated with a Mobile IPv4/6 foreign agent/attendant module 116 of the access node 114 as a care of address with its home agent 130 in its home network 128.

In FIG. 1, dashed line 146 represents a Mobile IPv4 or Mobile IPv6 tunnel established between the end node's home agent node 130 and Foreign Agent node 114 in accordance with the invention. In the case where the tunnel extends between the end node's home agent 130 and end node X 162, dashed line 148, between Foreign Agent node 114 and end node X 162, in addition to dashed line 146 represents part of a Mobile IPv4 or Mobile IPv6 tunnel. As will be discussed below tunnels 146, 148 can, and are, used to convey IPv4 or IPv6 packets while the tunnels themselves may be an IPv4 or an IPv6 tunnel.

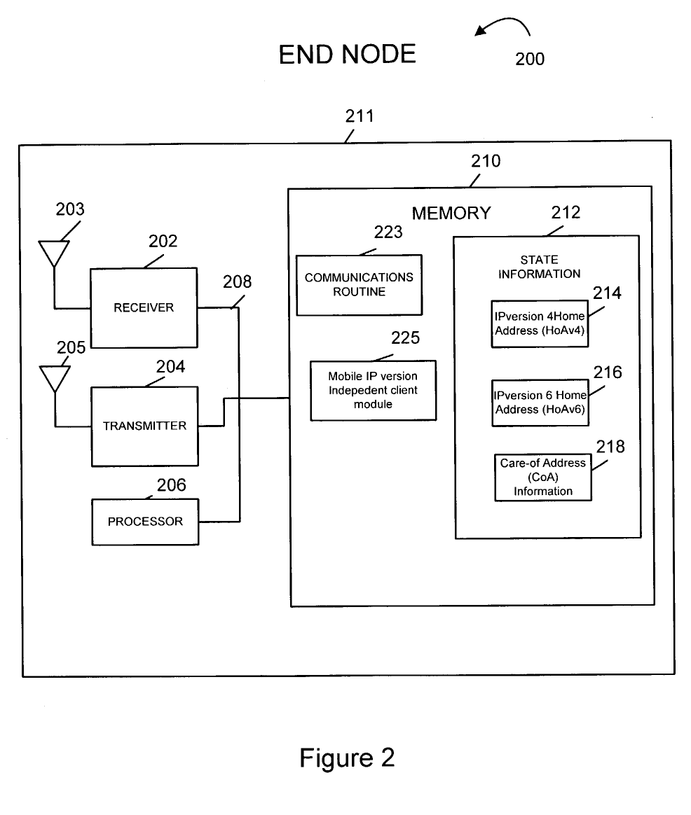

FIG. 2 illustrates an exemplary end node 200 which can be used in the system of FIG. 1, e.g., as end node X 162. In the FIG. 2 embodiment, the end node 200 includes a first antenna 203 coupled to a receiver unit 202, a second antenna 205 coupled to a transmitter unit 204, a processor 206 and memory 210, coupled together by bus 208. The elements 202, 204, 206, 208 and 210 of access node 200 are located inside a housing 211, e.g., a case of plastic and/or metal, represented by the rectangle surrounding the node's internal elements 202, 204, 206, 208 and 210. Accordingly, via bus 208 the various components of the access node 200 can exchange information, signals and data. Antennas 203, 205 with the corresponding receiver 202 and transmitter 204 provide a mechanism by which the internal components of the access node 200 can send and receive signals to/from external devices and network nodes. Antennas 203, 205 may extend outside the housing 211.

The processor 206 under control of various modules, e.g., routines, included in memory 210 controls operation of the end node 200 to perform various mobility management signaling, tunnel establishment and other operations as will be discussed below. The modules included in memory 210 are executed on startup or as called by other modules. Modules may exchange data, information, and signals when executed. Modules may also share data and information when executed. In the FIG. 2 embodiment, the memory 210 of access node 200 of the present invention includes a communications routine 223, a Mobile IP version independent client module 225 and state information 212. State information 212 includes, e.g., parameters, communication session and/or access node status information, security information, and/or other information relating to network node interaction and/or communication with an access node and/or another device. State information 212 also includes one or more IPversion4 Home Address (HoAv4) 214, IPversion6 Home Address (HoAv6) 216 and IPv4 and/or IPv6 Care-of-address (CoA) information 218.

The communications routine 223 is responsible for controlling communications between said end nodes and other nodes, e.g., other end nodes and/or network nodes. The mobile IP client module 225 allows the access node 200 to support mobility and connectivity management services. Thus, the end node 200 is capable of session establishment, and session maintenance services while moving between access nodes.

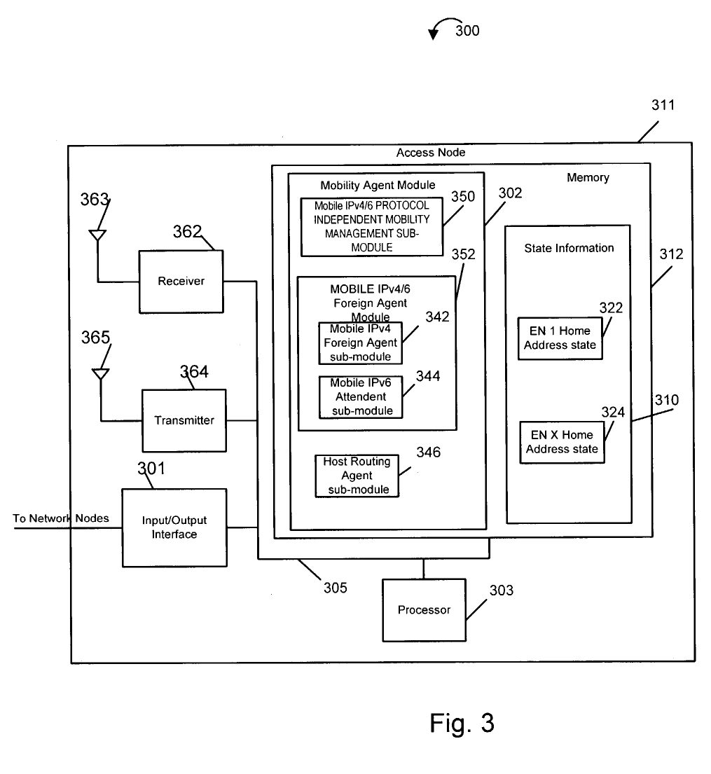

FIG. 3 illustrates an exemplary access node 300 which can be used in the system of FIG. 1, e.g., as visited access node 114 which serves as a Foreign Agent. In the FIG. 3 embodiment, the access node 300 includes an input/output interface 301, a first antenna 363 coupled to a receiver unit 362, a second antenna 365 coupled to a transmitter unit 364, a processor 303 and memory 312, coupled together by bus 305. The elements 301, 362, 364, 303, 312 and 305 of access node 300 are located inside a housing 311, e.g., a case of plastic and/or metal, represented by the rectangle surrounding the node's internal elements 301, 363, 362, 365, 364, 303, 312 and 305. Accordingly, via bus 305 the various components of the access node 300 can exchange information, signals and data. The antennas 363, 365 with the corresponding receiver unit 362 and transmitter unit 364 provide a mechanism by which the internal components of the access node 300 can send and receive signals to/from external devices such as end nodes. Antennas 363, 365 may extend outside housing 311. Input/output interface 301 provides a mechanism by which the internal components of access node 300 can interact, e.g., communicate with other network nodes, e.g., via fiber optic lines used to couple the interface 301 to the other network nodes.

The processor 303 under control of various modules, e.g., routines, included in memory 312 controls operation of the access node 300 to perform various signaling, session admission, resource allocation, authentication, and other operations as will be discussed below. The modules included in memory 312 are executed on startup or as called by other modules. Modules may exchange data, information, and signals when executed. Modules may also share data and information when executed. In the FIG. 3 embodiment, the memory 312 of access node 300 of the present invention includes a mobility agent module 302 and state information 310. State information 310 includes, e.g., parameters, communication session and/or end node status information, security information, and/or other information relating to end node interaction and/or communication with an access node and/or another device. State Information 310 also includes end node specific state including end node 1 Home Address State 322, end node X Home Address State 324. End node specific state 322, 324 indicates end nodes directly connected to access node 300, e.g., by a wireless link.

The mobility agent module 302 allows the access node 300 to support end node mobility and connectivity management services. Thus, the access node 300 is capable of providing node mobility, session establishment, and session maintenance services to connected end nodes. The mobility agent module 302 may be implemented in a plurality of ways. In the FIG. 3 embodiment it is implemented with a collection of sub-modules. As illustrated, the mobility agent module 302 includes a Mobile IPv4/6 Protocol Independent mobility management sub-module 350 in addition to sub-modules 352, 346. Sub-module 350 provides stack functionality among other things while sub-modules 352, 346 operate as a Mobile IPv4/6 Foreign Agent, and a Host Routing Agent, respectively. The mobile IPv4/6 protocol independent sub-module 350 allows Mobile IPv4 and/or Mobile IPv6 bindings to be communicated using either Mobile IPv4 or Mobile IPv6 signals. The Mobile IPv4/6 Foreign Agent sub module 352 further includes Mobile IPv4 Foreign Agent sub-module 342 and Mobile IPv6 Attendant sub-module 344. The Mobile IPv4/6 Protocol Independent Mobility Management Protocol of the present invention can be used to set-up tunnels on any network layer version over any other network layer version. By including sub-modules 342, 344 the mobility agent module 302 is capable of supporting multiple versions of Mobile IP signaling including Mobile IPv4 and Mobile IPv6 signaling. In various embodiments, the mobility agent module 302 includes a subset of the sub-modules 342, 344 and 346 shown in FIG. 3. For example, in embodiments where Mobile IPv6 is not required, the mobile IPv6 Attendant sub-module 344 may be omitted.

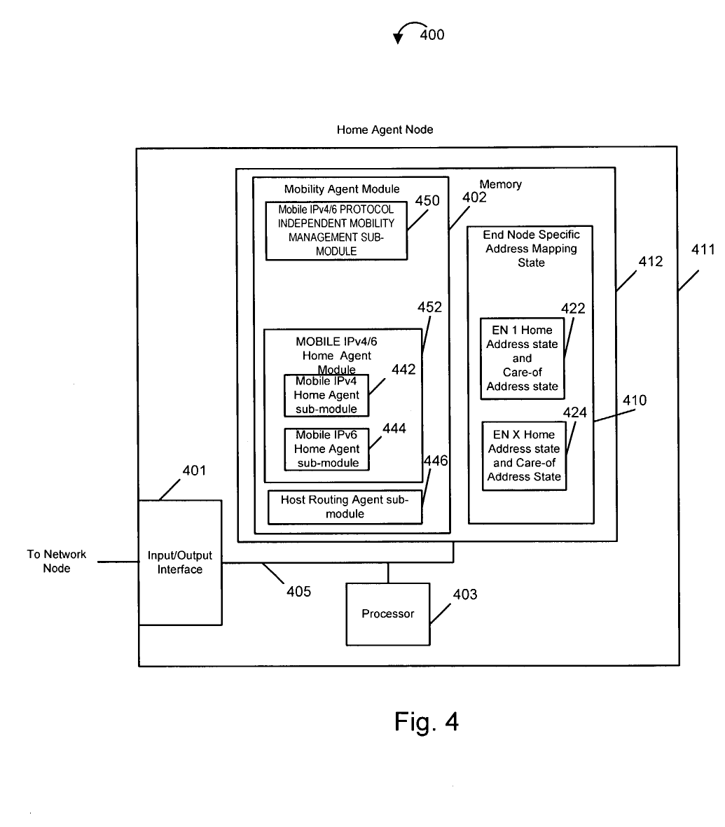

FIG. 4 illustrates an exemplary Home Agent node 400 which can be used in the system of FIG. 1, e.g., as home agent node 130 which serves as a Home Agent. In the FIG. 4 embodiment, the home agent node 400 includes an input/output interface 401, a processor 403 and memory 412, coupled together by bus 405. The elements 401, 403, 412, 405 of access node 400 are located inside a housing 411, e.g., a case of plastic and/or metal, represented by the rectangle surrounding the node's internal elements 401, 403, 412, 405. Accordingly, via bus 405 the various components of the access node 400 can exchange information, signals and data. The input/output interface 401 includes circuitry used for coupling the node 400 to other network nodes, e.g., via fiber optic lines, and potentially to end nodes, e.g., via wireless communications channels.

The processor 403 under control of various modules, e.g., routines, included in memory 412 controls operation of the home agent node 400 to perform various signaling, session admission, resource allocation, authentication, and other operations as will be discussed below. The modules included in memory 412 are executed on startup or as called by other modules. Modules may exchange data, information, and signals when executed. Modules may also share data and information when executed. In the FIG. 4 embodiment, the memory 412 of home agent node 400 of the present invention includes a mobility agent module 402 and state information 410. State information 410 includes, e.g., parameters, communication session and/or end node status information, security information, and/or other information relating to end node interaction and/or communication with an access node and/or another device. State Information 410 also includes end node specific state including mappings between end node's home addresses and care-of addresses e.g.: end node 1 Home Address State and care of address mapping state 422 and end node X Home Address and care-of address mapping state 424. End node specific state 422, 424 enables home agent node 400 to tunnel packets destined to a home address to a corresponding care-of address indicated in mappings 422, 424.

The mobility agent module 402 allows the node 400 to support end node mobility and connectivity management services. Thus, the home agent node 400 is capable of providing node mobility, session establishment, and session maintenance services to connected end nodes. The mobility agent module 402 may be implemented in a plurality of ways. In the FIG. 4 embodiment it is implemented with a collection of sub-modules. As illustrated, the mobility agent module 402 includes a Mobile IPv4/6 Protocol Independent mobility management sub-module 450 in addition to sub-modules 452, 446. Sub-module 450 provides stack functionality among other things while sub-modules 452, 446 operate as a Mobile IPv4/6 Home Agent, and a Host Routing Agent, respectively. The mobile IPv4/6 protocol independent sub-module 450 allows Mobile IPv4 and/or Mobile IPv6 bindings to be communicated using either Mobile IPv4 or Mobile IPv6 signals. The Mobile IPv4/6 Home Agent sub module 452 further includes Mobile IPv4 sub-module 442 and Mobile IPv6 sub-module 444. The Mobile IPv4/6 Protocol Independent Mobility Management Protocol of the present invention can be used to set-up tunnels on any network layer version over any other network layer version. By including sub-modules 442, 444 the mobility agent module 402 is capable of supporting multiple versions of Mobile IP signaling including Mobile IPv4 and Mobile IPv6 signaling. In various embodiments, the mobility agent module 402 includes a subset of the sub-modules 442, 444 and 446 shown in FIG. 4. For example, in embodiments where Mobile IPv6 is not required, the mobile IPv6 Home Agent sub-module 444 may be omitted.

One feature of the invention is directed to a method that runs using IPv4 and IPv6 and can set up IPv6 over IPv4, IPv4 over an IPv6 tunnel, IPv4 over an IPv4 tunnel, IPv6 over an IPv6 tunnel. Thus, IPv4 and/or IPv6 can be used with either an IPv4 or IPv6 tunnel. In this embodiment the mobile node is able to move in networks that support IPv4, IPv6 or both versions.

A second embodiment of this invention is a novel version of Mobile IPv4 with appropriate and novel extensions that enable an IPv4 and IPv6 node to use Mobile IPv4 to set up IPv6 over an IPv4 tunnel, IPv4 over an IPv6 tunnel, IPv4 over an IPv4 tunnel, IPv6 over IPv6 and/or any combination thereof. In this embodiment a mobile node is able to move in networks that support IPv4 or in networks that support IPv4 and IPv6 but not in networks that support IPv6 only.

A third embodiment of this invention is a novel version of Mobile IPv6 with appropriate and novel extensions that enable an IPv4 and IPv6 node to use Mobile IPv6 to set up IPv6 over IPv4, IPv4 over IPv6, IPv4 over IPv4, IPv6 over IPv6 tunnels. In this embodiment a mobile node is able to move in networks that support IPv6 or in networks that support IPv4 and IPv6.

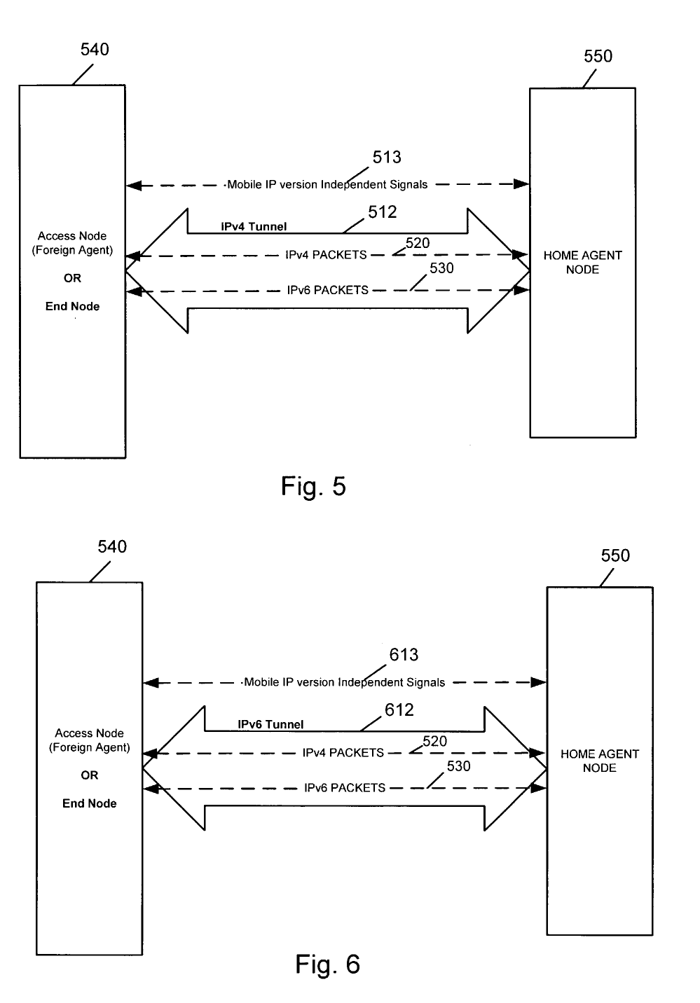

FIGS. 5 and 6 illustrate how IPv4 and IPv6 tunnels 512, 612, respectively, may be used in accordance with the invention. A single tunnel 512 or 612 would normally be used at any one tine. However, the invention does not preclude the use of multiple tunnels.

FIG. 5 depicts a Home Agent node 550, which is the same as or similar to the node 400 of FIG. 4, and a node 540. Depending on the mode of Mobile IP being used, i.e.: whether a Foreign Agent is used or not, node 540 is either an access node operating as Foreign Agent, in which case the node 540 is the same as, or similar to, the node 300 depicted in FIG. 3, or an end node. In the case where the node 540 is an end node, it may be the same as, or similar to, the exemplary end node 200 depicted in FIG. 2. When a Foreign Agent is used then signaling messages between the foreign agent 540 and the home agent 550 are sent on behalf of end nodes connected to the foreign agent 540 as illustrated in FIG. 1.

The Mobile IP version independent signal 513 is sent from node 540 to 550. Message 513 includes an IPv4 home address, an IPv6 home address and an IPv4 care-of address. On reception of message 513, Home Agent 550 stores in its state information 410 of FIG. 4 the mapping between the IPv4 and IPv6 home addresses included in message 513 and the IPv4 care of address also included in message 513.

Based on that state, the home agent creates an IPv4 tunnel 512 with source the address being its own home agent IPv4 address and the destination address the IPv4 care-of address. Packets sent to any of the home addresses, e.g.: IPv4 packets 520 and/or IPv6 packets 530, are encapsulated in IPv4 tunnel 512 by the home agent node 550 and sent to node 540. Node 540 decapsulates packets received with the care-of address as an outer destination address and recognizes them as its own when node 540 is an end node. When node 540 is a foreign agent, following decapsulation, the foreign agent compares the received packets inner destination address, which should be one of the home addresses in message 513, with addresses of directly connected nodes stored in its state information 310 of FIG. 3. If a match is found then the foreign agent forwards the decapsulated packets to the corresponding end node, e.g., via a wireless link.

FIG. 6 depicts the same Home Agent node 550 and node 540 as in FIG. 5. In this exemplary embodiment of the invention the Mobile IP version independent signal 613 is sent from node 540 to 550. Message 613 includes an IPv4 home address, an IPv6 home address and an IPv6 care-of address. On reception of message 613, Home Agent 550 stores in its state information 410 of FIG. 4 the mapping between the IPv4 and IPv6 home addresses included in message 613 and the IPv6 care of address also included in message 513.

Based on the state including the mapping between IPv4 and IPv6 home addresses, the home agent creates an IPv6 tunnel 612 with its own home agent IPv6 address as a source address and the IPv6 care-of address as a destination address. Packets sent to any of the home addresses in message 613, e.g.: IPv4 packets 520 and/or IPv6 packets 530, are encapsulated in IPv6 tunnel 612 and sent to node 540. Node 540 decapsulates packets received on the care-of address and recognize them as its own when node 540 is an end node. When node 540 is a foreign agent, following decapsulation, the foreign agent compares the internal, e.g., inner destination address, which should be one of the home addresses in message 613 with its state information 310 of FIG. 3. If a match is found, indicating the destination node is directly connected to the foreign agent node, then the foreign agent forwards the decapsulated packets to the corresponding end node, e.g., via a wireless link.

The IPv4 and IPv6 Tunnels 512, 612 of FIGS. 5 and 6 are set in the direction of Home Agent 550 to node 540 but can also be bi-directional based on normal Mobile IP signaling.

In one embodiment of this invention the base protocol used is Mobile IPv4. In this case the following novel extensions are introduced by this invention.

A new extension to the Mobile IPv4 header is defined herein for use in accordance with the present invention. The novel extension carries a 128 bit IPv6 address that is used in this invention to identify the IPv6 home address of the mobile node and the IPv6 care of address when one is used.

In one embodiment of this invention the novel extension is implemented in accordance to the short extension format of [MIPv4]. Such an extension will have

| | | | |
|---|---|---|---|
| Type (1 byte) | Length (1 byte) | Sub-Type (1 byte) | Body (16 bytes) |

| | | | |
|---|---|---|---|
| TBA* | 17 | 1 for IPv6 home | IPv6 address or |
| | | address | prefix |
| | | 2 for IPv6 | |
| | | care-0f-address | |

*To Be Assigned by the numbering authority

The mobile IP agents supporting this invention advertise support for the novel method in their agent advertisements which are transmitted to various nodes. In one embodiment of this invention a new flag is added to the agent advertisement header format to indicate support for IPv6 extensions.

Flag A IP Version 6 extensions supported.

In one exemplary embodiment, Mobile IPv4 Home Agents that, according to this invention are prepared to support IPv6 for mobile nodes, set the A flag. Foreign Agents that according with this invention are prepared to support mobile clients with IPv6 home addresses set the A flag.

A Foreign Agent access router implemented in accordance with the invention may receive IPv6 packets from directly connected mobile nodes either via direct delivery or via encapsulated delivery style and reverse tunnels them to the home agent [REVTUN]. Such an access router, for the purposes of this invention is called “limited dual stack” foreign agent. In an alternative embodiment of this invention a foreign agents access router supporting the methods of the invention advertises in parallel one or more IPv6 network prefixes in routing advertisements as part of standard IPv6 neighbor discovery, in which case the access router is called, for purposes of explaining the invention, a “full dual stack” foreign agent.

Mobile clients that receive a home agent advertisement with no A flag set ignore IPv6 extensions in foreign agent advertisements and do not attempt to use the IPv6 extensions in any of their registration requests. Any IPv6 capable node can use IPv6 routing advertisements received from an access router to form IPv6 addresses according to [AUTO]. A mobile node supporting the present invention uses such addresses as care-of addresses in the novel IPv6 care-of address extension in a registration request. A mobile IP client supporting the methods of this invention includes one or more IPv6 address extensions described herein for use in a registration request. When IPv6 address extensions described for use in accordance with the invention are used, they are normally placed immediately after the registration request header and are included in the computation of any authentication extension.

A dual stack home agent that supports the IPv6 extensions used in accordance with this invention, keeps track of the following IPv6 related state for the mobile IP clients it supports in addition to what state is defined in [MIPv4].

the mobile node's IPv6 home address

the mobile node's IPv6 care-of-address

A home agent that supports this invention intercepts IPv4 and IPv6 packets destined to registered mobile nodes according to mechanisms described in [MIPv4] and [MIPv6] specifications. All intercepted traffic is tunneled to the registered care-of address of the corresponding mobile node.

A “limited dual stack” foreign agent of this invention keeps track of the following IPv6 related state for the mobile nodes it supports in addition to what state is defined in [MIPv4].

Mobile node's IPv6 home address

Such a foreign agent accepts registration requests that include an IPv6 home address extension and reject registration requests that include an IPv6 care-of address extension. It is also prepared to handle IPv6 traffic for the mobile by delivering it to the mobile after de-capsulation of IPv4 headers received from the home agent or by reverse tunneling over IPv4 to the home agent after receiving IPv6 packets from the mobile.

A “full dual stack” foreign agent keeps track of the following IPv6 related state for the mobile IP clients it supports in addition to what state is defined in [MIPv4].

Mobile node's IPv6 home address

Mobile node's IPv6 co-located address

Such a dual stack router and foreign agent accepts registration requests that include a IPv6 care-of address and/or IPv6 home address extension. Such a foreign agent is prepared to route IPv6 natively or reverse tunnel according to the end node's requests.

If a mobile node does not receive any indication of IPv6 support i.e.: neighbor discovery traffic from an access router apart from the A flag in a foreign agent routing advertisement then, it sets the T flag (reverse tunneling) if it adds an IPv6 home address extensions to a registration request. In one embodiment of this invention the registration request also includes the encapsulated delivery option to enable reverse tunneling of IPv6 packets and direct delivery of IPv4 packets.

If a mobile node does not receive any indication of IPv6 support then in one embodiment of this invention it registers with an IPv4 co-located care-of address, in which case it sets the T flag (reverse tunneling) if it adds an IPv6 home address extensions to a registration request. In this case reverse tunneling from the mobile to it home agent is used for all IPv6 traffic.

If a mobile node receives normal IPv6 neighbor advertisement messages from an access router on the link then in one embodiment of this invention it includes an IPv6 care of address extension in its registration request.

If the mobile node does not have an IPv6 home address pre-configure it needs to form one dynamically. In one embodiment of this invention the mobile sends a zero IPv6 home address extension. The home agent allocates a home address from its subnet and returns it in the same extension.

In a second embodiment a mobile sends a zero IPv6 home address and the home agent returns a prefix allocated to the mobile (for network allocation). The prefix is sent in the IPv6 home address extensions as PREFIX::. In this case any packet sent to that PREFIX is to be tunneled to said mobile.

In a third embodiment a mobile sends 0::EU164 in an IPv6 home address extension, where EU164 is the link layer address of the mobile. The home agent fills in its mobile network prefix and returns PREFIX::EU164 or just PREFIX:: if it allocates a subnet.

In still another embodiment a mobile sends its EUI64 in a link layer address extension and the home address returns the IPv6 home address extensions as PREFIX::EU164 or as PREFIX:: if it allocates a whole subnet.

Extensions to the same effect can be devised so that a Mobile IPv6 based protocol can be implemented.

The methods and apparatus of the present invention are applicable to a wide range of communications systems including, e.g., OFDM systems, CDMA systems, and various other types of cellular and non-cellular systems which support the use of IP for communications purposes.

The receiver and transmitter circuits of the nodes of the present invention include, in various implementations, buffers for storing messages received and/or transmitted, respectively, in accordance with the present invention. The buffers may be internal to the receiver and transmitter circuitry or part of the nodes main memory. In addition, as part of the message generation processes performed by various nodes, e.g., end nodes and access nodes, the novel messages of the present invention are stored, at least temporarily, in memory in many cases. Various features of the present invention are directed to machine readable medium, e.g., receiver buffers, transmitter buffers, or other memory, which store the novel messages of the present invention. Among the novel messages which may be stored in a machine readable memory are a mobile IP message including first and second mobile IP home addresses, said first and said second mobile IP home addresses being in different formats, said different formats corresponding to different versions of IP. In one embodiment the first mobile IP home address is a 32 bit address and the second mobile IP home address is a 128 bit address. In another embodiment the first and second mobile IP home addresses are 128 bit addresses, one of said addresses including 32 bits used to specify a mobile IP home address and 94 padding bits. The novel message of the invention may, and in several implementations does, also include a first care of address being in a format corresponding to one of said different versions of IP.

In various embodiments nodes described herein are implemented using one or more modules to perform the steps corresponding to one or more methods of the present invention, for example, signal processing, message generation and/or transmission steps. Thus, in some embodiments various features of the present invention are implemented using modules. Such modules may be implemented using software, hardware or a combination of software and hardware. Many of the above described methods or method steps can be implemented using machine executable instructions, such as software, included in a machine readable medium such as a memory device, e.g., RAM, floppy disk, etc. to control a machine, e.g., general purpose computer with or without additional hardware, to implement all or portions of the above described methods, e.g., in one or more nodes. Accordingly, among other things, the present invention is directed to machine-readable medium including machine executable instructions for causing a machine, e.g., processor and associated hardware, to perform one or more of the steps of the above-described method(s).

Numerous additional variations on the methods and apparatus of the present invention described above will be apparent to those skilled in the art in view of the above description of the invention. Such variations are to be considered within the scope of the invention. The methods and apparatus of the present invention may be, and in various embodiments are, used with CDMA, orthogonal frequency division multiplexing (OFDM), and/or various other types of communications techniques which may be used to provide wireless communications links between access nodes and mobile nodes. In some embodiments the access nodes are implemented as base stations which establish communications links with mobile nodes using OFDM and/or CDMA. In various embodiments the mobile nodes are implemented as notebook computers, personal data assistants (PDAs), or other portable devices including receiver/transmitter circuits and logic and/or routines, for implementing the methods of the present invention.

What is claimed is:

1. A mobile communication method, the method comprising:
operating a home agent to receive a mobile IP message, said message including:
first and second mobile IP home addresses, said first and said second mobile IP home addresses being in different formats, said different formats corresponding to different versions of IP.

2. The method of claim 1, wherein the first mobile IP home address is a 32 bit address and the second mobile IP home address is a 128 bit address.

3. The method of claim 1, wherein the first and second mobile IP home addresses are 128 bit addresses, one of said addresses including 32 bits used to specify a mobile IP home address and 94 padding bits.

4. The method of claim 1, wherein the received mobile IP message further includes:
a first care of address being in a format corresponding to one of said different versions of IP.

5. The method of claim 1, wherein said Mobile IP message is a Mobile IPv4 Registration Request.

6. The method of claim 1, wherein said Mobile IP message is a Mobile IPv6 Binding Update.

7. The method of claim 4, further comprising:
operating the home agent to store information associating said first and second home addresses with said first care of address.

8. The method of claim 7, further comprising:
operating the home agent to receive a packet including a destination address, said destination address being one of said first and second home addresses; and
operating the home agent to encapsulate said received packet to generate a new packet including at least a portion of said received packet, said new packet including said care of address as a destination address.

9. The method of claim 8, wherein operating the home agent to encapsulate includes:
accessing said stored information associating said first and second home addresses with the first care of address to determine the care of address to be used as said destination address.

10. The method of claim 9, further comprising:
transmitting said new packet to a foreign agent; and
operating said foreign agent to decapsulate said new packet to retrieve the packet received by the home agent.

11. The method of claim 10, further comprising:
operating the foreign agent to compare a destination address in the retrieved packet to stored information listing addresses of mobile nodes directly connected to said foreign agent to determine if said destination address corresponds to a node directly connected to said foreign agent; and
in response to determining that a mobile node corresponding to said destination address corresponds to a node directly connected to said foreign agent, operating the foreign agent to transmit said retrieved packet to said mobile node to which the destination address corresponds.

12. The method of claim 11,
wherein said foreign agent is included in a base station; and
wherein a wireless communications link directly couples said base station and said foreign agent included therein to the mobile node.

13. The method of claim 1, wherein said received mobile IP message further includes:
first and second care of addresses, said first and said second care of addresses being in different formats, said different formats corresponding to said different versions of IP, said first care of address being associated with said first home address and said second care of address being associated with said second home address.

14. The method of claim 1, further comprising:
operating a device to transmit said mobile IP message to said home agent.

15. The method of claim 14, wherein said device is a mobile node, the method further comprising:
operating said mobile node to generate said message from stored information including said first and second home addresses.

16. The method of claim 15, wherein said stored information associates said first and second home addresses with a single care of address; and
wherein generating said message includes incorporating said single care of address in said message.

17. The method of claim 14, wherein said device is a foreign agent, the method further comprising:
operating said foreign agent to receive a message from a mobile node including said first and second home address; and
operating said foreign agent to store said first and second home addresses.

18. The method of claim 17, further comprising:
operating said foreign agent to generate the message received by said home agent from at least a portion of the message received from said mobile node; and
operating the foreign agent to transmit said message to said home agent.

19. A communications system comprising:
a home agent node, the home agent node including:
means for receiving IP packets;
a set of address information associating first and second mobile IP home addresses, in first and second formats, with a care-of-address, said first and second formats being different; and
means for performing an encapsulation operation on a received packet including a destination address which is one of said first and second packets to generate a new packet including at least a portion of said received packet, said new packet including said care of address as a destination address.

20. The communications system of claim 19, wherein said first mobile IP home address is a 32 bit address and the second mobile IP address is a 128 bit address.

21. The communications system of claim 19, further comprising:
means for receiving a mobile IP message including said first and second mobile IP home addresses and said care-of-address; and
a memory device for storing said first and second mobile IP home addresses and said care-of address in association with one another.

22. The communication system of claim 21, further comprising a foreign agent node, said foreign agent node including:
a database of addresses corresponding to end nodes connected to said foreign agent node, at least one entry in said database including two addresses corresponding to the same end node, said two addresses having different formats.

23. The communications system of claim 22, wherein said foreign agent node further includes:
means for decapsulating a packet received from said home agent node, to retrieve a packet originally received by said home agent node; and
means for comparing a destination address included in the retrieved packet to destination addresses included in said database of addresses.

24. The communications system of claim 23, wherein the foreign agent node further includes:
means for transmitting said retrieved packet to an end node over a wireless communications link.

25. The communications system of claim 22, wherein said foreign agent node further includes:
means for receiving a message from an end node including said first and second mobile IP addresses which have different formats; and
means for storing said first and second mobile IP addresses in said database.

26. A machine readable medium comprising:
a mobile IP message, said message including:
first and second mobile IP home addresses, said first and said second mobile IP home addresses being in different formats, said different formats corresponding to different versions of IP.

27. The machine readable medium of claim 26, wherein the first mobile IP home address is a 32 bit address and the second mobile IP home address is a 128 bit address.

28. The machine readable medium of claim 26, wherein the first and second mobile IP home addresses are 128 bit addresses, one of said addresses including 32 bits used to specify a mobile IP home address and 94 padding bits.

29. The machine readable medium of claim 26, wherein the received mobile IP message further includes:
a first care of address being in a format corresponding to one of said different versions of IP.

30. The machine readable medium of claim 29, wherein the machine readable medium is a data storage device in a node of a communications network.

31. The machine readable medium of claim 30, wherein said data storage device is a communications buffer.

32. A node in a mobile communications system, node comprising:
means for generating a mobile IP message including first and second mobile IP home addresses, said first and said second mobile IP home addresses being in different formats, said different formats corresponding to different versions of IP.

33. The node of claim 32, wherein said node is a mobile node, the node further comprising:
stored information including said first and second home addresses.

34. The node of claim 33,
wherein said stored information associates said first and second home addresses with a single care of address; and
wherein generating said message includes incorporating said single care of address in said message.

35. The node of claim 34, wherein said node further includes a transmission buffer for storing said message prior to transmission.

36. The node of claim 32, wherein said node is a foreign agent node, the node further comprising:
means for receiving a message from a mobile node including said first and second home addresses; and
memory for storing said first and second home addresses.

37. The node of claim 36, further comprising:
means for generating said mobile IP message from at least a portion of the message received from said mobile node; and
means for transmitting said message to a home agent corresponding to said mobile node.

38. The node of claim 37, wherein said means for receiving includes a buffer for storing the message received from the mobile node.
